(19) United States
(12) Patent Application Publication
(10) Pub. No.: US 2019/0256406 A1
(43) Pub. Date: Aug. 22, 2019

(54) DECORATIVE NON-POROUS LAYERS FOR ION-EXCHANGEABLE GLASS SUBSTRATES

(71) Applicant: CORNING INCORPORATED, CORNING, NY (US)

(72) Inventors: Bruce Gardiner Aitken, Corning, NY (US); Marie Jacqueline Monique Comte, Fontenay aux Roses (FR); Philippe Lehuede, Dammarie-les-Lys (FR)

(21) Appl. No.: 16/061,588

(22) PCT Filed: Dec. 12, 2016
(86) PCT No.: PCT/US2016/066115

§ 371 Date: Jun. 12, 2018

Related U.S. Application Data
(60) Provisional application No. 62/268,124, filed on Dec. 16, 2015.

(51) Int. Cl. C03C 8/08; C03C 8/04; C03C 8/14; C03C 17/04; C03C 21/00; B32B 17/10

(52) U.S. Cl. CPC C03C 8/08; C03C 8/04; C03C 8/14; C03C 17/04; C03C 21/002; B32B 2605/006; B32B 17/10137; B32B 17/10266; C03C 2209/00; C03C 2217/72; B32B 2315/08; B32B 17/10036

(57) ABSTRACT

Disclosed are non-porous inorganic frit compositions, which permit the decoration of ion-exchangeable glass-based substrates before the ion exchange chemical strengthening processes. When fired, the non-porous inorganic frit compositions comprise a crystallized phase and/or a ΔT greater than about 80° C. Also disclosed are strengthened glass-based substrates having one or more non-porous inorganic layers, glass-based articles comprising strengthened glass-based substrates having one or more non-porous inorganic layers, and methods of making the same.

### CROSS-REFERENCE TO RELATED APPLICATIONS

This application claims the benefit of priority under 35 U.S.C. § 119 of U.S. Provisional Application Ser. No. 62/268,124 filed on Dec. 16, 2015 the content of which is relied upon and incorporated herein by reference in its entirety.

The disclosure relates to inorganic frit compositions, strengthened glass-based substrates having decorative layers comprising non-porous inorganic frit compositions, glass-based articles optionally comprising strengthened glass substrates and having decorative layers comprising non-porous inorganic frit compositions, and methods for making the same.

### SUMMARY

Ion exchange strengthening is used to improve the mechanical resistance of glass-based substrates and articles in numerous applications ranging from hand-held consumer smart-phones and electronic tablets to automotive glazing. As used herein, the terms “glass-based substrates” and “glass-based article” are used in their broadest sense to include any object made wholly or partly of glass. Glass-based articles include laminates of glass and non-glass materials, laminates of glass and crystalline materials, and glass-ceramics (including an amorphous phase and a crystalline phase). Unless otherwise specified, all compositions are expressed in terms of mole percent (mol %).

By way of example only, ion exchange strengthening is of particular interest in automotive glazing. Conventional automotive glazing is typically formed from soda-lime silica glass that has been thermally tempered to induce a surface compressive stress and improve the resistance of the glazing to mechanical failure following damage such as scratches, chips or the like. However, the amount of residual compressive stress imparted by thermal tempering is not high (on the order of 200 MPa-300 MPa). Accordingly, thermally tempered automotive glazing needs to be relatively thick to assure that the glazing will withstand high mechanical loads before failure occurs. As such, automotive glazing glass may have a thickness on the order of about 7 mm. However, there is a need in the automotive and other glass industries to decrease the weight of the glazing by reducing the thickness of the glass articles.

Ion exchange processes generally impart a greater amount of compressive stress (typically on the order of 600 MPa to 1200 MPa) to glass compared to thermal tempering processes; therefore, ion exchanged glass-based articles generally have a greater resistance to mechanical failure than similar glass-based articles which are thermally tempered. This means that the ion exchanged glass-based articles may be formed with a reduced thickness while still retaining the same or even improved resistance to mechanical failure relative to thermally tempered glass-based articles. As such, ion exchange processes may be particularly useful in the automotive glass industry.

However, in automotive glazing glass or any application where ion exchange processes are used, there is a further challenge when strengthening glass-based articles having decorative layers made from glass frits thereon. Specifically, commercial decorative frits are generally unusable with ion exchange strengthening processes. Conventionally, no ion exchange could be achieved under the decorative glass frit layer. Moreover, compressive stresses would be released if the decoration occurred after the ion exchange, due to the softening temperature of the frits being higher than the exchange temperature.

Accordingly, in various embodiments, the present disclosure relates to frit compositions which permit the decoration of ion-exchangeable glass-based substrates before the ion exchange chemical strengthening processes. The frit compositions comprise P₂O₅, Nb₂O₅, ZnO, and Na₂O, and optionally at least one of TiO₂, K₂O, Li₂O, SiO₂, Al₂O₃ and/or pigments. When fired, the frit compositions provide layers that are non-porous, and comprise a crystallized phase and/or a ΔT greater than about 80° C. In some embodiments, the frit compositions provide inorganic frit layers. Such frit compositions may be useful in any application where a non-porous layer, e.g. a non-porous, decorative inorganic layer, is desired on a glass-based substrate.

In further embodiments, the disclosure relates to articles including a glass-based substrate and one or more non-porous inorganic decorative layers. In some embodiments, the articles include strengthened glass-based substrates and one or more non-porous inorganic decorative layers.

In yet further embodiments, the disclosure relates to methods for forming strengthened glass-based substrates having one or more decorative non-porous inorganic layers. The methods comprise depositing a layer of a frit composition onto a glass-based substrate (which may be ion-exchangeable), wherein the frit composition comprises P₂O₅, Nb₂O₅, ZnO, and Na₂O; and firing the glass-based substrate and deposited frit composition layer at a temperature and for a time sufficient to form a decorated glass-based substrate comprising a non-porous inorganic frit composition layer having a crystallized phase and/or a ΔT greater than about 80° C. In one or more embodiments, the method includes strengthening the decorated glass-based substrate by subjecting the decorated glass-based substrate to an ion-exchange process.

These and additional features provided by the embodiments of the present disclosure will be more fully understood in view of the following detailed description, in conjunction with the drawings.

### BRIEF DESCRIPTION OF THE DRAWINGS

FIG. 1 illustrates a laminate comprising an internal strengthened glass substrate and an external glass substrate and a glass fit, according to one or more embodiments;

FIG. 2 is a perspective view of a vehicle including the laminate of FIG. 1;

FIG. 3 shows the microstructure of the non-porous inorganic decorative layer obtained with the frit composition of Example 2, after firing at 700° C. for 30 minutes;

FIG. 4 shows the microstructure of the non-porous inorganic decorative layer obtained with the frit composition of Example 5, after firing at 700° C. for 30 minutes;

FIG. 5 shows the microstructure of the non-porous inorganic decorative layer obtained with the frit composition of Example 3, after firing at 650° C. for 15 minutes;

FIG. 6 shows an SEM image of the non-porous inorganic decorative layer obtained with the frit composition of Example 5, after deposition onto the glass-based substrate and firing at 700° C. for 30 minutes;

FIG. 7 shows an image taken with a polarizing microscope of the non-porous inorganic decorative layer obtained with the frit composition of Example 3 after deposition onto the glass-based substrate, firing at 500° C. for one hour and 600° C. for two hours and after being subjected to ion exchange at 410° C. for 7 hours, 45 minutes;

FIG. 8 shows an image taken with a polarizing microscope of the non-porous inorganic decorative layer obtained with the frit composition of Example 2, firing at 650° C. for 15 minutes, and after being subjected to ion exchange strengthening of the decorated glass-based substrate in a KNO₃ bath at 410° C. for 7 hours, 30 minutes;

FIG. 9 is a graph showing content of sodium and potassium in a chemically strengthened glass substrate and in the non-porous inorganic decorative layer obtained with the frit composition of Example 3 after it was deposited onto the glass-based substrate, fired at 650° C. for 15 minutes, before and after ion exchange strengthening of the decorated glass-based substrate in a KNO₃ bath at 410° C. for 8 hours; and

FIGS. 10A-10D show SEM/EDX images of the non-porous inorganic decorative layer obtained with frit composition of Example 3 deposited onto the glass-based substrate, fired at 650° C. for 15 minutes after ion exchange strengthening of the decorated glass-based substrate in a KNO₃ bath at 410° C. for 8 hours.

The embodiments set forth in the figures are illustrative in nature and not intended to be limiting of the invention defined by the claims. Moreover, individual features of the drawings will be more fully apparent and understood in view of the detailed description.

### DETAILED DESCRIPTION

The following detailed description of specific embodiments of the present disclosure is intended to be illustrative only and not limiting, with alternate embodiments contemplated to be included, and can be best understood when read in conjunction with the drawings enclosed herewith.

Embodiments of the disclosure relate to frit compositions and strengthened glass-based substrates having one or more decorative non-porous layers, glass-based articles comprising strengthened glass-based substrates having one or more decorative non-porous layers, and methods for making the same.

### Non-Porous Inorganic Decorative Layers

According to various embodiments of the disclosure, the glass frit composition is in the P₂O₅—Nb₂O₅—TiO₂—ZnO—Na₂O—K₂O—Li₂O—Al₂O₃—SiO₂ field. The composition may comprise P₂O₅, Nb₂O₅, ZnO, and Na₂O. The composition may further, in at least some embodiments, comprise TiO₂. Optionally, the composition may, in some embodiments, further comprise one or more of K₂O, Li₂O, and SiO₂. In yet further embodiments, the compositions may optionally comprise Al₂O₃.

According to at least certain exemplary embodiments, the glass frit composition may comprise from about 30 mol % to about 40 mol % P₂O₅, such as from about 35 mol % to about 38 mol %; from about 5 mol % to about 15 mol % Nb₂O₅, such as from about 7 mol % to about 13 mol %; from about 15 mol % to about 30 mol % ZnO, such as from about 19 mol % to about 25 mol %; and from about 15 mol % to about 30 mol % Na₂O, such as from about 19 mol % to about 25 mol %.

In one or more embodiments, the glass frit may comprise P₂O₅ in an amount in a range from about 30 mol % to about 40 mol %, from about 32 mol % to about 40 mol %, from about 34 mol % to about 40 mol %, from about 35 mol % to about 40 mol %, from about 30 mol % to about 39 mol %, from about 30 mol % to about 38 mol %, from about 30 mol % to about 36 mol %, from about 30 mol % to about 35 mol %, from about 32 mol % to about 38 mol %, from about 34 mol % to about 38 mol %, or from about 35 mol % to about 38 mol %.

In one or more embodiments, the glass frit may comprise Nb₂O₅ in an amount in a range from about 5 mol % to about 15 mol %, from about 6 mol % to about 15 mol %, from about 8 mol % to about 15 mol %, from about 10 mol %, from about 5 mol % to about 12 mol %, from about 5 mol % to about 10 mol %, from about 5 mol % to about 8 mol %, from about 7 mol % to about 13 mol %, from about 8 mol % to about 12 mol %, or from about 9 mol % to about 11 mol %.

In one or more embodiments, the glass frit may comprise ZnO in an amount in a range from about 15 mol % to about 30 mol %, from about 16 mol % to about 30 mol %, from about 18 mol % to about 30 mol %, from about 20 mol % to about 30 mol %, from about 22 mol % to about 30 mol %, from about 24 mol % to about 30 mol %, from about 15 mol % to about 28 mol %, from about 15 mol % to about 26 mol %, from about 15 mol % to about 25 mol %, from about 15 mol % to about 24 mol %, from about 15 mol % to about 22 mol %, from about 15 mol % to about 20 mol %, from about 18 mol % to about 26 mol %, or from about 19 mol % to about 25 mol %.

In one or more embodiments, the glass frit may comprise Na₂O in an amount in a range from about 15 mol % to about 30 mol %, from about 16 mol % to about 30 mol %, from about 18 mol % to about 30 mol %, from about 20 mol % to about 30 mol %, from about 22 mol % to about 30 mol %, from about 24 mol % to about 30 mol %, from about 15 mol % to about 28 mol %, from about 15 mol % to about 26 mol %, from about 15 mol % to about 25 mol %, from about 15 mol % to about 24 mol %, from about 15 mol % to about 22 mol %, from about 15 mol % to about 20 mol %, from about 18 mol % to about 26 mol %, or from about 19 mol % to about 25 mol %.

In one or more embodiments, the glass frit may include a non-zero amount of TiO2. In some embodiments, the glass frit may be substantially free of TiO2. As used herein, “substantially free” includes less than 0.05 mol % of a given constituent. When present, the frit composition may comprise up to about 20 mol % TiO₂, such as up to about 15 mol %, up to about 10 mol %, or up to about 5 mol %.

In one or more embodiments, the glass frit may include a non-zero amount of Al₂O₃. In some embodiments, the glass frit may be substantially free of Al₂O₃. In one or embodiments, the frit composition may comprise up to about 10 mol % of Al₂O₃ (e.g., up to about 7 mol %, up to about 5 mol %, or up to about 3 mol %).

In one or more embodiments, the glass frit may include a non-zero amount of Li₂O. In some embodiments, the glass frit may be substantially free of Li₂O. In one or embodiments, the frit composition may comprise up to about 10 mol % of Li₂O (e.g., up to about 7 mol %, up to about 5 mol %, or up to about 3 mol %).

In one or more embodiments, the glass frit may include a non-zero amount of SiO₂. In some embodiments, the glass frit may be substantially free of SiO₂. In one or embodiments, the frit composition may comprise up to about 10 mol % of SiO₂ (e.g., up to about 7 mol %, up to about 5 mol %, or up to about 3 mol %).

In one or more embodiments, the glass frit may include a non-zero amount of K₂O. In some embodiments, the glass frit may be substantially free of K₂O. When present, the frit composition may comprise up to about 20 mol % of K₂O, such as up to about 15 mol %, up to about 10 mol %, up to about 7 mol %, up to about 5 mol %, or up to about 3 mol %.

The glass frit may be mixed with binders, rheology agents, pigments and any other component typically used in preparing an inorganic decoration, to prepare a paste or frit composition that can be used for decorating glass substrates. In some embodiments, when fired, organic components of the frit composition are removed, leaving an inorganic decoration or inorganic layer.

Various pigments are contemplated for use according to at least some embodiments of the disclosure, depending on the application and the color of the decorative layer. For example and not by way of limitation, the following table (Table 1) lists optional suitable commercial pigments that may achieve various desired pigment colors:

TABLE 1

| Desired Pigment | |
|---|---|
| Color | Possible Pigments |
| Black | CuCrFe, CrFe, manganese ferrite spinel, FeCrCoNi |
| Blue | Cobalt aluminate, cobalt chromite spinel, CoZnCrAl |
| Green | Cobalt titanate green spinel |
| Brown | Manganese antimony titanium buff rutile, zinc iron |
| | chromite brown spinel, iron titanium brown spinel |
| Orange | Rutile tin zinc |
| Violet | Cobalt phosphate |
| Yellow | Nickel antimony titanium yellow rutile, niobium sulfur |
| | tin zinc oxide |
| Metallic | Mica flakes covered with titanate or titanate + tin |
| aspect | oxide or iron oxide |

Various amounts of pigments are contemplated based on the desired color, desired opacity and desired application. For example, the decorative non-porous inorganic layer may comprise from about 10 wt % to about 50 wt % of pigment, such as from about 15 wt % to about 30 wt %, or from about 20 wt % to about 25 wt %.

According to various embodiments of the disclosure, the non-porous inorganic frit compositions comprise a crystallized phase after firing. In at least some embodiments, the crystallized phase is an NZP-type phase. By “NZP-type” it is meant a crystalline phase that is isostructural with sodium zirconium phosphate, which can include, for example, NASICON (Na₃Zr₂(PO₄)(SiO₄)₂).

In various embodiments, the coefficient of thermal expansion (“CTE”) of the non-porous inorganic decorative layer may be compatible with (i.e. may substantially match, such as within about 10×10⁻⁷/° C.) the CTE of the glass-based substrate on which a decorative layer thereof is deposited. By way of example only, the non-porous inorganic decorative layer may have a CTE ranging from about 60×10⁻⁷/° C. to about 110×10⁻⁷/° C., such as about 70×10⁻⁷/° C. to about 100×10⁻⁷/° C., about 75×10⁻⁷/° C. to about 95×10⁻⁷/° C., or about 80×10⁷/° C. to about 90×10⁻⁷/° C. In one embodiment, the CTE of the non-porous inorganic decorative layer ranges from about 75×10⁷/° C. to about 96×10⁻⁷/° C., and in another embodiment, the CTE of the non-porous inorganic decorative layer is less than about 100×10⁻⁷/° C., such as from about 90×10⁷/° C. to about 100×10⁻⁷/° C. or from about 90×10⁻⁷/° C. to about 95×10⁻⁷/° C., for example about 95×10⁻⁷/° C. or about 90×10⁻⁷/° C.

In various embodiments, as described herein, the temperature of the onset of crystallization (“Tx”) of the frit compositions (or the crystallization onset temperature of the frit composition), when measured at a heating rate of 10° C./minute, can range up to about 800° C., such as up to about 750° C., up to about 725° C., up to about 700° C., up to about 675° C., up to about 650° C., up to about 625° C., up to about 600° C., or up to about 575° C. In some instances, the lower limit of the Tx range may be about 400° C., or 500° C.

The glass transition temperature (“Tg”) of the frit compositions ranges up to about 600° C., such as up to about 575° C., up to about 550° C., up to about 525° C., or up to about 500° C. In various embodiments, the Tg of the frit composition may range from about 400° C. to about 600° C.

It may, in various exemplary embodiments, be desirable for the frit compositions to display a large temperature difference (ΔT) between Tx and Tg (i.e. Tx−Tg=ΔT). Without wishing to be bound by theory, it is believed that a large ΔT of the non-fired frit improves thermal stability as the frit does not crystallize prematurely during the firing process, which can increase viscosity and decrease or prevent flow. Thus, a ΔT of greater than about 75° C., such as greater than about 80° C., greater than about 85° C., greater than about 90° C., or greater than about 95° C., may be achieved.

### Preparing Non-Porous Inorganic Decorative Layers and Decorated Glass-Based Substrates

The frit may be prepared by any method which results in a frit composition having the properties described herein. In one embodiment, the process may include mixing and melting the raw materials (or compositional components) in a vessel (e.g. a silica or platinum crucible) at a temperature above 1000° C., such as from about 1000° C. to about 1600° C., for example in a furnace set at a temperature ranging from about 1200° C. to about 1500° C., to form a glass. After the glass is obtained, it is ground and sieved to produce a frit precursor. Alternative processes include, by way of example only, pouring the melted glass directly into water to facilitate further grinding and drying, or rolling it into sheet with steel roller and crushing it. Optionally for deposition purposes, a rheology modifier or binder may be added to the frit powder to obtain a paste. Various compositions are contemplated as suitable for producing a paste from the frit powder. In one embodiment, the paste may include an organic binder such as pine oil, but other compositions are contemplated herein, for example, amyl acetate nitrocellulose.

By way of non-limiting example, melting of the raw materials may be performed in a heating vessel (e.g., platinum or silica crucible in a furnace) at a temperature ranging from about 1200° C. to about 1500° C. In some embodiments, an amount of raw materials (e.g., 250-350 g) may then be progressively introduced into the crucible. Fining may be simultaneously performed at the same temperature, for example for a period of time up to about 3 hours. The glass may be quenched by any known method, for example by pouring it into water and dried. The cullet may then be ground and sieved to produce a frit precursor, with glass particles having a d₅₀ on the order or about 1.4 μm to about 1.8 μm, and a d₉₀ on the order of about 3.2 μm to about 3.6 μm.

A rheology modifier or binder, e.g. an organic binder such as pine oil or amyl acetate nitrocellulose, and optionally pigments if desired, can be added and a paste formed. The paste may then be deposited, e.g. as a decorative layer, onto a glass-based substrate by any known method, such as, for example, screen printing, digital scanning printing, inkjet printing, etc. Once the decorative layer is deposited onto the glass-based substrate, the glass-based substrate with the frit layer is then fired in a furnace at a temperature ranging from about 500° C. to about 750° C., such as from about 600° C. to about 700° C., with heating and cooling ramps ranging from about 20° C./min to about 50° C./min, such as from about 21° C./min to about 45° C./min. Dwell times may range up to about 2 hours, such as up to about 1 hour, up to about 30 minutes, up to about 20 minutes, up to about 10 minutes, or up to about 5 minutes. This process forms a crystallized phase, resulting in good adherence of a non-porous, decorative layer of the frit composition to the glass-based substrate.

After firing, the decorative layer may have any thickness on the substrate, for example a thickness ranging from about 10 μm to 40 μm, from about 20 μm to about 30 μm, or from about 20 μm to about 25 μm, according to various embodiments. Multiple decorative layers may be added, if desired.

### Glass-Based Substrates

In one or more embodiments, the glass-based substrate may include soda lime glass, aluminosilicate glass compositions, alkali-free glass compositions, alkali-containing glass compositions (e.g., alkali aluminosilicate glass compositions and alkali aluminoborosilicate glass compositions). In some embodiments, the glass-based substrate may include an ion-exchangeable glass composition. As used herein, “ion-exchangeable” means that the glass-based material or substrate comprising the composition is capable of exchanging cations located at or near the surface of the material with cations of the same valence that are either larger or smaller in size.

One example of an ion-exchangeable glass composition suitable for the glass-based substrate comprises SiO₂, B₂O₃ and Na₂O, where (SiO₂+B₂O₃)≥66 mol %, and Na₂O≥9 mol %. In a further embodiment, the glass-based substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the material can comprise 61-75 mol % SiO2; 7-15 mol % Al₂O₃; 0-12 mol % B₂O₃; 9-21 mol % Na₂O; 0-4 mol % K₂O; 0-7 mol % MgO; and 0-3 mol % CaO.

A further example of an ion-exchangeable glass composition suitable for the glass-based substrate comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; where 12 mol %≤(Li₂O+Na₂O+K₂O)≤20 mol % and 0 mol %≤(MgO+CaO)≤10 mol %.

A still further example of an ion-exchangeable glass composition suitable for the glass-based substrate comprises: 63.5-66.5 mol % SiO₂; 8-12 mol % Al₂O₃; 0-3 mol % B₂O₃; 0-5 mol % Li₂O; 8-18 mol % Na₂O; 0-5 mol % K₂O; 1-7 mol % MgO; 0-2.5 mol % CaO; 0-3 mol % ZrO₂; 0.05-0.25 mol % SnO₂; 0.05-0.5 mol % CeO₂; less than 50 ppm As₂O₃; and less than 50 ppm Sb₂O₃; where 14 mol %≤(Li₂O+Na₂O+K₂O)≤18 mol % and 2 mol %≤(MgO+CaO)≤7 mol %.

In a particular embodiment, an alkali aluminosilicate glass composition suitable for the glass-based substrate comprises alumina, at least one alkali metal and, in some embodiments, greater than 50 mol % SiO₂, in other embodiments at least 58 mol % SiO₂, and in still other embodiments at least 60 mol % SiO₂, wherein the ratio ((Al₂O₃+B₂O₃)/Σmodifiers)>1, where in the ratio the components are expressed in mol % and the modifiers are alkali metal oxides. This glass composition, in particular embodiments, comprises: 58-72 mol % SiO₂; 9-17 mol % Al₂O₃; 2-12 mol % B₂O₃; 8-16 mol % Na₂O; and 0-4 mol % K₂O, wherein the ratio ((Al₂O₃+B₂O₃)/Σmodifiers)>1.

In still another embodiment, the glass-based substrate may include a glass composition comprising: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≤SiO₂+B₂O₃+CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂O₃≤2 mol %; 2 mol %≤Na₂O—Al₂O₃≤6 mol %; and 4 mol %≤(Na₂O+K₂O)—Al₂O₃≤10 mol %.

In yet another embodiment, the glass-based substrate may comprise an alkali aluminosilicate glass composition comprising: 2 mol % or more of Al₂O₃ and/or ZrO₂, or 4 mol % or more of Al₂O₃ and/or ZrO₂.

In one or more embodiments, the glass composition may specifically include from about 62 mol % to 75 mol % SiO₂; 10.5 mol % to about 17 mol % Al₂O₃; 5 mol % to about 13 mol % Li₂O; 0 mol % to about 4 mol % ZnO; 0 mol % to about 8 mol % MgO; 2 mol % to about 5 mol % TiO₂; 0 mol % to about 4 mol % B₂O₃; 0 mol % to about 5 mol % Na₂O; 0 mol % to about 4 mol % K₂O; 0 mol % to about 2 mol % ZrO₂; 0 mol % to about 7 mol % P₂O₅; 0 mol % to about 0.3 mol % Fe₂O₃; 0 mol % to about 2 mol % MnOx; and 0.05 mol % to about 0.2 mol % SnO₂.

In one or more embodiments, the glass composition may include from about 67 mol % to about 74 mol % SiO₂; from about 11 mol % to about 15 mol % Al₂O₃; from about 5.5 mol % to about 9 mol % Li₂O; from about 0.5 mol % to about 2 mol % ZnO; from about 2 mol % to about 4.5 mol % MgO; from about 3 mol % to about 4.5 mol % TiO₂; from about 0 mol % to about 2.2 mol % B₂O₃; from about 0 mol % to about 1 mol % Na₂O; from about 0 mol % to about 1 mol % K₂O; from about 0 mol % to about 1 mol % ZrO₂; from about 0 mol % to about 4 mol % P₂O₅; from about 0 mol % to about 0.1 mol % Fe₂O₃; from about 0 mol % to about 1.5 mol % MnOx; and from about 0.08 mol % to about 0.16 mol % SnO₂.

In one or more embodiments, the glass composition may include from about 70 mol % to 75 mol % SiO₂; from about 10 mol % to about 15 mol % Al₂O₃; from about 5 mol % to about 13 mol % Li₂O; from about 0 mol % to about 4 mol % ZnO; from about 0.1 mol % to about 8 mol % MgO; from about 0 mol % to about 5 mol % TiO₂; from about 0.1 mol % to about 4 mol % B₂O₃; from about 0.1 mol % to about 5 mol % Na₂O; from about 0 mol % to about 4 mol % K₂O; from about 0 mol % to about 2 mol % ZrO₂; from about 0 mol % to about 7 mol % P₂O₅; from about 0 mol % to about 0.3 mol % Fe₂O₃; from about 0 mol % to about 2 mol % MnOx; and from about 0.05 mol % to about 0.2 mol % SnO₂.

In some embodiments, the glass-based article may include a glass-ceramic, the crystal phases may include β spodumene, rutile, gahnite or other known crystal phases and combinations thereof.

As one exemplary and non-limiting embodiment, the glass-based substrate onto which the non-porous inorganic frit composition is deposited may comprise a chemically strengthened glass substrate having a composition as described in U.S. Patent Publication No. 2011/0045961, assigned to Corning Incorporated, and incorporated by reference herein in its entirety.

Various thicknesses are contemplated for the glass-based substrate. As non-limiting examples only, the glass-based substrate may include a thickness of from about 0.1 mm to about 4.0 mm, such as from about 0.5 to about 2.0 mm, or from about 0.7 mm to about 1.5 mm.

The glass-based substrate may be strengthened. As used herein, the term “strengthened glass-based substrate” refers to glass-based substrates that are strengthened chemically, mechanically, thermally or by various combinations of chemically, mechanically and/or thermally, to impart compressive stress regions at the surface exhibiting a compressive stress (CS), and a central region exhibiting tensile stress. The CS region that extends from a surface of the substrate to a depth of compression (DOC). As used herein DOC refers to the depth at which the stress transitions from compressive to tensile. Unless otherwise specified, CT and CS are expressed herein in megaPascals (MPa), whereas thickness and DOC are expressed in millimeters or microns.

A mechanically-strengthened glass-based substrate may include a compressive stress region and a central tension region generated by a mismatch of the coefficient of thermal expansion between portions of the substrate. A chemically-strengthened glass-based substrate may include a compressive stress region and a central tension region generated by an ion exchange process. In a chemically strengthened glass-based substrate, the replacement of smaller ions by larger ions at a temperature below that at which the glass network can relax produces a distribution of ions across the surface of the glass that results in a stress profile. The larger volume of the incoming ion produces a CS on the surface portion of the substrate and tension (CT) in the center of the glass. In a thermally-strengthened glass-based substrate, the CS region is formed by heating the substrate to an elevated temperature above the glass transition temperature, near the glass softening point, and then cooling the glass surface regions more rapidly than the inner regions of the glass. The differential cooling rates between the surface regions and the inner regions generates a residual surface CS, which in turn generates a corresponding CT in the center region of the glass-based substrate. In one or more embodiments, the glass-based substrate excludes annealed soda lime glass.

### Methods for Making Strengthened Glass-Based Substrates Comprising Non-Porous Frit Layer

In at least certain embodiments, it is desirable to subject the decorated glass-based substrate to a strengthening process, such as an ion-exchange process, after the decorative layer of the non-porous, inorganic frit composition is deposited and fired thereon. As such, a method according to one or more embodiments may include preparing a frit composition as described herein, depositing it onto any suitable non-strengthened glass-based substrate by any method, and subsequently firing the glass-based substrate and deposited frit composition to form a decorated glass-based substrate. In some embodiments, the method includes strengthening the decorated glass-based substrate using a strengthening process, such as an ion exchange process. In some instances, the strengthening process may include a chemical strengthening process, a mechanical strengthening process, a thermally or a combination of any one or more of a chemical, mechanical and thermal strengthening process.

In one or more embodiments, strengthening the decorated glass-based substrate may include chemically strengthening the glass-based substrate by immersing the glass-based substrate into a molten salt bath for a predetermined period of time such that ions at or near the surface(s) of the glass-based substrate are exchanged for larger metal ions from the salt bath. For example, the temperature of the molten salt bath may be in the range from about 350° C. to about 500° C., such as about 380° C. to about 480° C., 400° C. to about 460° C., or about 400° C. to about 430° C., and the predetermined time period is typically up to about 24 hours; however the temperature and duration of immersion may vary according to the composition of the material and the desired attributes. The incorporation of the larger ions into the glass-based substrate strengthens the substrate by creating a compressive stress in a near surface region or in regions at and adjacent to the surface(s) of the substrate. A corresponding tensile stress is induced within a central region or regions at a distance from the surface(s) of the material to balance the compressive stress. Glass-based substrates utilizing this strengthening process may be described more specifically as chemically-strengthened or ion-exchanged glass-based substrates.

In various embodiments, sodium ions in a glass-based substrate are replaced by potassium ions from the molten bath, such as a potassium nitrate salt bath, though other alkali metal ions having larger atomic radii, such as rubidium or cesium, can replace smaller alkali metal ions in the glass-based substrate. According to particular embodiments, smaller alkali metal ions in the glass-based substrate can be replaced by Ag+ ions. Similarly, other alkali metal salts such as, but not limited to, sulfates, phosphates, halides, and the like may be used in the ion exchange process.

By way of example only, the decorated glass-based substrate may be immersed in a KNO₃ bath at a temperature ranging from about 400° C. to about 430° C., such as from about 410° C. to about 420° C., or about 410° C., for a period of time sufficient for a sufficient amount of Na+ ions from the decorative layer and/or glass-based substrate to be exchanged with the K+ ions from the bath, such as from about 2 to about 24 hours, such as about 5 to about 15 hours, or about 7 to about 9 hours.

While various ion exchange parameters may be adjusted as desired, the ion exchange process may be selected so as to achieve properties of the glass-based substrate under the decoration layer that are the same or substantially the same as the glass-based substrate that is not decorated, including but not limited to ion concentration, CS, modulus of rupture (“MOR”), DOC, and/or mechanical resistance to flexion. For example, the ion exchange process may be conducted at a temperature of about 390° C. to about 500° C., or about 410° C. to about 450° C. for about 5 to about 15 hours, as appropriate to achieve the desired properties. In various embodiments, MOR values greater than about 300 MPa, such as greater than about 325 MPa, greater than about 350 MPa, greater than about 375 MPa, or greater than about 400 MPa; and/or a DOC greater than about 20 μm, such as greater than about 25 μm, greater than about 30 μm, greater than about 35 μm, greater than about 40 μm, or greater than about 45 μm; and/or mechanical resistance to flexion (Ring-on-Ring or “ROR” configuration) greater than about 400 MPa, may be achieved.

In addition to the improvements described above, additional advantages are seen with the inorganic frit compositions according to the present disclosure. For example, compared to porous inorganic frit composition layers, the present disclosure provides deeper colorations and more scratch-resistant layers, which may also be more resistant to staining. Further, in automotive glazing applications (e.g., sunroofs and windshields), it may be easier to decorate the interior or concave portion of the glass-based article without degrading the cosmetic aspect due to diffusion of the silicone glue into the porosity of the decoration.

In addition, for automotive glazing applications (e.g., sunroofs and windshields), applying the decorative non-porous inorganic layer prior to ion exchange may yield other advantages as compared to a post-ion exchange decoration processes. For example, production costs are lowered for the present process, because there is no additional process step. Another advantage is that the present process allows a simple standard screen printing decoration process on flat glass-based substrates as well as more complicated 3D shape samples.

Accordingly, glass-based articles comprising or incorporating the strengthened glass-based substrates having one or more non-porous inorganic layers are also within the scope of the disclosure. Such articles include, but are not limited to, screens or encasings for smart phones, electronic tablets, and the like, and automotive glazings, such as windshields, sunroofs, and architectural panels such as windows, interior wall panels, modular furniture panels, backsplashes, cabinet panels, and/or appliance panels.

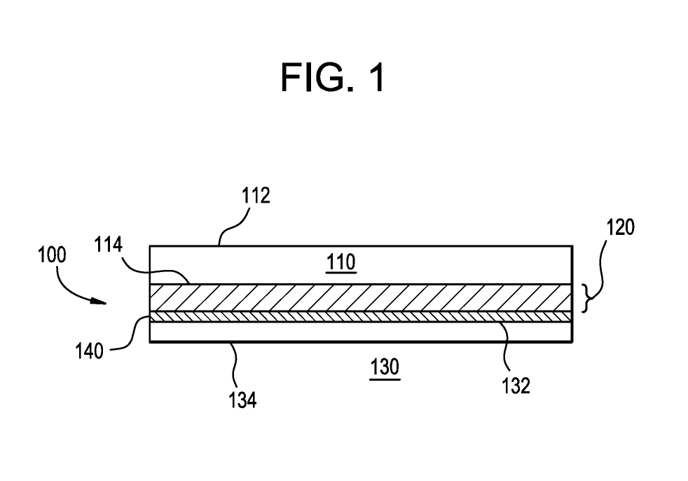

When used in glazing, the frit may be applied a laminate 100 that includes an external glass substrate 110, an internal glass substrate 130 and an intervening polymer interlayer 120 disposed between the external glass substrate and the internal glass substrate, as shown in FIG. 1. Either one or both the external and internal glass substrates may be strengthened as described herein. In one embodiment, the internal glass substrate is strengthened (e.g., chemically strengthened aluminosilicate glass), while the external glass substrate comprises an unstrengthened glass, which may be optionally annealed (e.g., annealed soda lime silicate glass). The strengthened glass substrate may have a thickness of about 1.5 mm or less (e.g., 1.2 mm or less, 1.1 mm or less, 1 mm or less, 0.8 mm or less, 0.7 mm or less, 0.5 mm or less, 0.4 mm or less, with a lower limit of 0.1 mm). In one or more embodiments, the unstrengthened glass substrate may have a thickness greater than the strengthened glass substrate. For example, the unstrengthened glass substrate may have a thickness greater than about 1.5 mm (e.g., 1.6 mm or greater, 1.8 mm or greater, 1.9 mm or greater, 2 mm or greater, 2.1 mm or greater, 2.2 mm or greater, 2.4 mm or greater, 2.5 mm or greater, 2.6 mm or greater, 2.8 mm or greater, 3 mm or greater, 3.2 mm or greater, 3.5 mm or greater, 4 mm or greater, or 4.5 mm or greater, with the upper limit being 6 mm). In one or more embodiments, the laminate is configured to be an automotive glazing for an automobile, and the external glass substrate faces an outside environment of the automobile and the internal strengthened glass substrate faces an interior of the automobile. The frit 140 is shown as applied to surface 132 of the internal glass substrate in FIG. 1; however, frit 140 may be applied any one or more of surfaces 112, 114, 132, 134 of the external glass substrate and internal glass substrate.

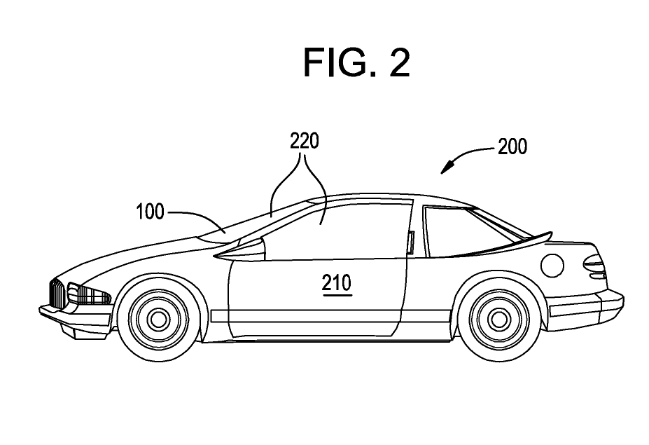

An illustration of a vehicle 200 with an embodiment of the laminate is shown in FIG. 2. The vehicle includes a body 210 defining an interior and at least one opening 220 in the body. As used herein, the term “vehicle” may include automobiles (e.g., cars, vans, trucks, semi-trailer trucks, and motorcycles), rolling stock, locomotives, train cars, airplanes, and the like. The opening 220 is a window in communication with the interior of the vehicle and the exterior of the vehicle. The laminate 100 is disposed within then at least one opening 220 to provide a transparent covering. The internal glass substrate 130 as shown in FIG. 1 (and in particular surface 134) would face the interior of the vehicle while the external glass substrate 110 (and in particular fourth glass surface 112) would face the exterior of the vehicle.

Although the foregoing refers to various exemplary embodiments, it will be understood that the disclosure is not so limited. It will occur to those of ordinary skill in the art that various modifications may be made to the disclosed embodiments and that such modifications are intended to be within the scope of the disclosure. Where an embodiment employing a particular structure and/or configuration is illustrated in the present disclosure, it is understood that the present disclosure may be practiced with any other compatible structures and/or configurations that are functionally equivalent provided that such substitutions are not explicitly forbidden or otherwise known to be impossible to one of ordinary skill in the art.

It is also to be understood that, as used herein the terms “the,” “a,” or “an,” mean “at least one,” and should not be limited to “only one” unless explicitly indicated to the contrary. Thus, for example, reference to “a layer” includes examples having two or more layers unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. For example, the phrase “from about A to C, such as B,” is intended to convey at least the following: “about A to about C,” “exactly A to exactly C,” “about A to exactly C,” “exactly A to about C,” “about A to about B,” “exactly A to exactly B,” “about A to exactly B,” “exactly A to about B,” “about B to about C,” “exactly B to exactly C,” “about B to exactly C,” “exactly B to about C,” “about A,” “exactly A,” “about B,” “exactly B,” “about C,” and “exactly C.”

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method does not actually recite an order to be followed by its steps or it is not otherwise specifically stated in the claims or descriptions that the steps are to be limited to a specific order, it is not intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

Aspect (1) of this disclosure pertains to an inorganic frit composition comprising: P₂O₅ in an amount ranging from 30 mol % to about 40 mol %, Nb₂O₅ in an amount ranging from about 5 mol % to about 15 mol %, ZnO in an amount ranging from about 15 mol % to about 30 mol %, and Na₂O in an amount ranging from about 15 mol % to about 30 mol %.

Aspect (2) pertains to the inorganic frit composition according to Aspect (1), comprising: P₂O₅ in an amount ranging from about 35 mol % to about 38 mol %,

Nb₂O₅ in an amount ranging from about 7 mol % to about 13 mol %, ZnO in an amount ranging from about 19 mol % to about 25 mol %, and Na₂O in an amount ranging from about 19 mol % to about 25 mol %.

Aspect (3) pertains to the inorganic frit composition according to Aspect (1) or Aspect (2), wherein the composition comprises a crystallization onset temperature when measured at a heating rate of 10° C./minute (Tx), a glass transition temperature, and a ΔT greater than about 80° C., wherein ΔT is the difference between Tx and Tg.

Aspect (4) pertains to the inorganic frit composition according to any one of Aspect (1) through Aspect (3), further comprising at least one of TiO₂, K₂O, Li₂O, SiO₂, and Al₂O₃.

Aspect (5) pertains to the inorganic frit composition according to any one of Aspect (1) through Aspect (4), further comprising at least one pigment.

Aspect (6) pertains to the inorganic frit composition according to any one of Aspect (1) through Aspect (5), which is fired.

Aspect (7) pertains to the inorganic frit composition according to any one of Aspect (1) through Aspect (6), comprising an NZP-type crystalline phase.

Aspect (8) of this disclosure pertains to an article comprising: a strengthened glass-based substrate; and a non-porous inorganic frit composition layer comprising P₂O₅, Nb₂O₅, ZnO, and Na₂O, wherein the non-porous inorganic frit composition layer comprises an NZP-type crystalline phase.

Aspect (9) of this disclosure pertains to the article according to Aspect (8), wherein the non-porous inorganic frit composition layer further comprises at least one of TiO₂, K₂O, Li₂O, SiO₂, and Al₂O₃.

Aspect (10) of this disclosure pertains to the article according to Aspect (8) or Aspect (9), wherein the non-porous inorganic frit composition layer further comprises at least one pigment.

Aspect (11) pertains to the article according to any one of Aspect (8) through Aspect (10), wherein the glass-based substrate comprises aluminosilicate glass or aluminoborosilicate glass.

Aspect (12) pertains to the article according to any one of Aspect (8) through Aspect (11), wherein the CTE of the inorganic frit composition layer is compatible with the CTE of the glass-based substrate.

Aspect (13) pertains to a method of forming a strengthened glass-based substrate, said method comprising: providing an ion-exchangeable glass-based substrate; depositing a layer of a frit composition onto the glass-based substrate, wherein the frit composition comprises P₂O₅, Nb₂O₅, ZnO, and Na₂O, and a crystallization onset temperature when measured at a heating rate of 10° C./minute (Tx), a glass transition temperature, and a ΔT greater than about 80° C., wherein ΔT is the difference between Tx and Tg; firing the glass-based substrate and deposited frit composition layer at a temperature and for a time sufficient to form a decorated glass-based substrate comprising a non-porous inorganic frit composition layer having an NZP-type crystalline phase; and strengthening the decorated glass-based substrate by subjecting the decorated glass-based substrate to an ion-exchange process.

Aspect (14) of this disclosure pertains to the method according to Aspect (13), wherein the ion-exchangeable glass-based substrate comprises aluminosilicate glass or alum inoborosilicate glass.

Aspect (15) of this disclosure pertains to the method according to Aspect (13) or Aspect (14), wherein the frit composition comprises P₂O₅ in an amount ranging from about 35 mol % to about 38 mol %, Nb₂O₅ in an amount ranging from about 7 mol % to about 13 mol %, ZnO in an amount ranging from about 19 mol % to about 25 mol %, and Na₂O in an amount ranging from about 19 mol % to about 25 mol %.

Aspect (16) of this disclosure pertains to the method according to any one of Aspect (13) through Aspect (15), wherein firing the glass-based substrate and deposited frit composition layer comprises firing at a temperature ranging from about 500° C. to about 750° C., during 5 minute intervals with heating and cooling ramps ranging from about 20° C./min to about 50° C./min.

Aspect (17) of this disclosure pertains to the method according to any one of Aspect (13) through Aspect (16), wherein strengthening the decorated glass-based substrate by subjecting the decorated glass-based substrate to an ion-exchange process comprising immersing the decorated glass-based substrate in a KNO₃ bath at a temperature ranging from about 400° C. to about 480° C. for a period ranging from about 1 hour to about 24 hours.

Aspect (18) of this disclosure pertains to the method according to any one of Aspect (13) through Aspect (17), wherein the CTE of the non-porous inorganic frit composition layer is compatible with the CTE of the glass-based substrate.

Aspect (19) of this disclosure pertains to the method according to any one of Aspect (13) through Aspect (18), wherein the strengthening achieves a DOC greater than about 20 μm and/or MOR values greater than about 300 MPa.

Aspect (20) of this disclosure pertains to a laminate an external glass substrate comprising an unstrengthened glass substrate; an interlayer disposed on the external glass substrate; an internal glass substrate disposed on the interlayer, the internal glass substrate comprising a chemically strengthened glass substrate; and the inorganic frit of any one of Aspect (1) through Aspect (12) disposed on at least one or both the external glass substrate and the internal glass substrate.

Aspect (21) of this disclosure pertains to a vehicle comprising: a body defining an interior; an opening in the body in communication with the interior; and the laminate of Aspect (20) disposed in the opening.

Aspect (22) pertains to the vehicle of Aspect (21), wherein the body comprises an automobile body, a railcar body, or an airplane body, wherein the internal glass substrate faces the interior.

### EXAMPLES

The following Examples are intended to be non-restrictive and explanatory only, with the scope of the invention being defined by the claims.

### Examples 1-7

Table 2 below shows exemplary inorganic frit compositions, where the amounts given are in mol %.

TABLE 2
Compositions

| | 1 | 2 | 3 | 4 | 5 | 6 | 7 |
|---|---|---|---|---|---|---|---|
| P₂O₅ | 37.5 | 36.89 | 36.29 | 35.71 | 36.89 | 36.89 | 35.89 |
| Na₂O | 25 | 24.59 | 24.19 | 23.81 | 22.59 | 19.59 | 19.59 |
| ZnO | 25 | 22.94 | 20.97 | 19.05 | 22.94 | 22.94 | 22.94 |
| TiO₂ | 0 | 4.92 | 9.68 | 14.29 | 4.92 | 4.92 | 4.92 |
| Nb₂O₅ | 12.5 | 10.66 | 8.87 | 7.14 | 10.66 | 10.66 | 10.66 |
| Li₂O | 0 | 0 | 0 | 0 | 2 | 0 | 0 |
| K₂O | 0 | 0 | 0 | 0 | 0 | 5 | 0 |
| SiO₂ | 0 | 0 | 0 | 0 | 0 | 0 | 6 |

All of the compositions in Table 2 were prepared as follows. The compositions were melted in a silica crucible in a furnace at a temperature between 1200° C. and 1500° C., after which 250-350 g of raw materials were progressively introduced into the crucible. Fining was simultaneously performed at the same temperature, for 1-3 hours. The glass was quenched by pouring it into water and dried at 120° C. The cullet was then ground and sieved to produce a frit precursor with glass particles having a d₅₀ of 1.6 μm, and a d₉₀ of 3.4 μm. Pine oil was added and a paste formed. The paste was then deposited by conventional screen printing as a decorative layer onto the glass substrate which was 0.7 or 1.1 mm thick chemically strengthened aluminosilicate glass substrate, and the glass substrate with the decorative layer was then fired in a furnace set at a temperature ranging from 600° C. to 700° C., during 5 minute intervals with heating and cooling ramps from 21° C./min to 45° C./min.

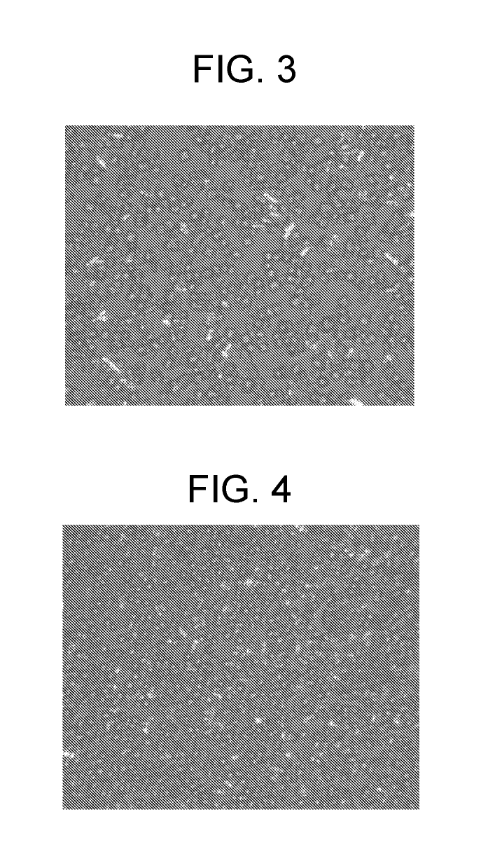

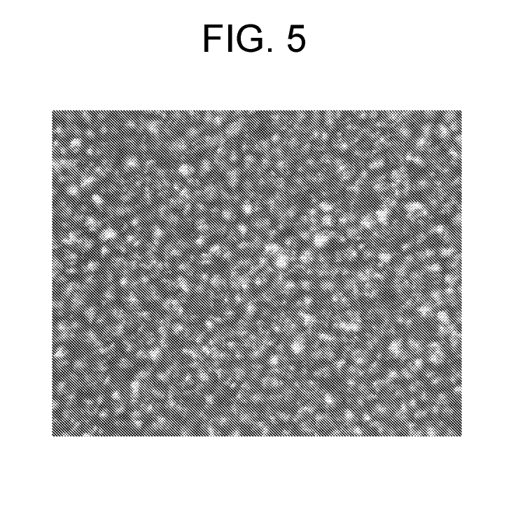

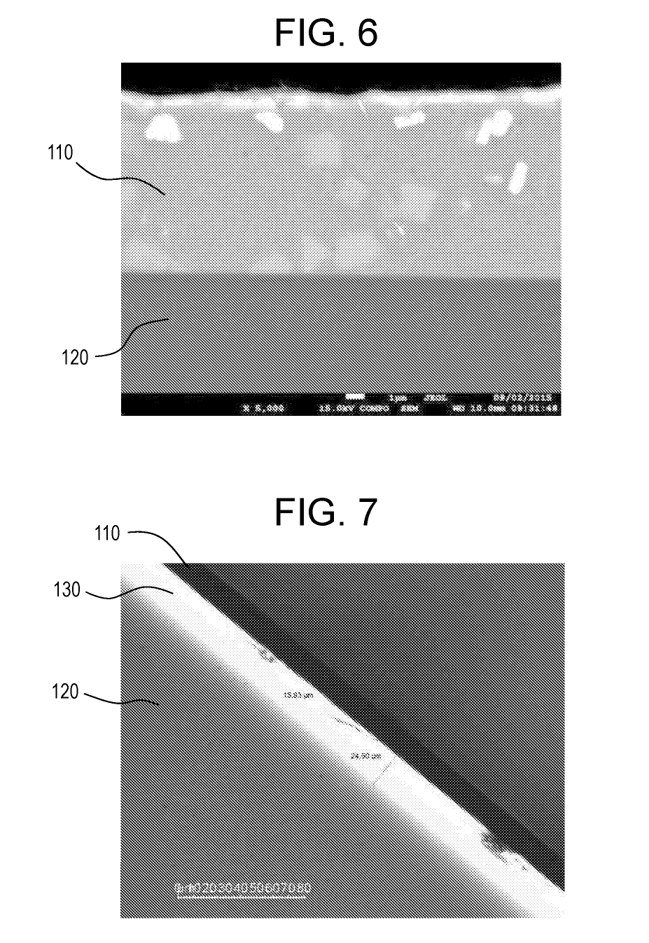

FIGS. 3-5 show microstructures of three decorative layers after firing, obtained with a polarizing microscope (2000× magnification). These figures demonstrate that, depending on the composition, different amounts of the crystallized phase can be seen. FIG. 6 shows a scanning electron micrograph (“SEM”) image of a decorative layer of inorganic frit composition 110 on the chemically strengthened aluminosilicate glass substrate, demonstrating a lack of porosity.

The decorative layer of the non-porous, inorganic frit had good adhesion to the glass-based substrate, and was approximately 15 μm thick. The decorated substrates demonstrated little to no warpage, which indicated that the CTEs of the decorative layers were compatible with that of the chemically strengthened aluminosilicate glass substrate.

X-ray diffraction analysis of the fired decorative layers demonstrated the presence of an NZP-type phase.

The Tg, Tx, ΔT, and CTE (both before and after firing) for each of Examples 1-7 were determined, the results of which are shown in Table 3.

TABLE 3
Properties of decorative layer compositions

| | 1 | 2 | 3 | 4 | 5 | 6 | 7 |
|---|---|---|---|---|---|---|---|
| Tg (° C.) | 431 | 459 | 487 | 493 | 453 | 460 | 478 |
| Tx (° C.) | 586 | 582 | 637 | 589 | 642 | 702 | 659 |
| | 676 | 672 | | | | | |
| ΔT (° C.) | 155 | 123 | 150 | 96 | 189 | 242 | 181 |
| CTE before | | 105 | 101 | | 105 | 106 | 94 |
| treatment | | | | | | | |
| (×10⁻⁷/° C.) | | | | | | | |
| CTE after | | | 87 | | 95 | | 78 |
| treatment | | | | | | | |
| (×10⁻⁷/° C.) | | | | | | | |

After the glass-based substrates with the decorative layers were fired and cooled to room temperature, the substrates from Examples 2-5 were strengthened by immersion in a KNO₃ bath at a temperature of 410° C. to 430° C. DOC and MOR measurements were taken, the results of which are set forth in Table 4.

TABLE 4
Properties of strengthened glass-based substrates with decorative layer

| | Ex. 2 | Ex. 2 | Ex. 3 | Ex. 3 | Ex. 4 | Ex. 4 | Ex. 5 |
|---|---|---|---|---|---|---|---|
| | 650° C., | 700° C., | 650° C., | 500° C./1 h + | 650° C., | 500° C./1 h + | 700° C., |
| | 15 min | 30 min | 10 min | 600° C./2 h | 10 min | 600° C./2 h | 30 min |
| DOC¹ (μm) | 34 | 21 | 38 | 27 | 45 | 41 | 25 |
| DOC² (μm) | 28 | | | 24 | | | |
| Mean MOR³ | 425 | | | 328 | | | |
| (MPa) | | | | | | | |

¹= measured by SEM/EDX profile;
²= measured on a slice;
³= Weilbull distribution - Ring on Ring configuration

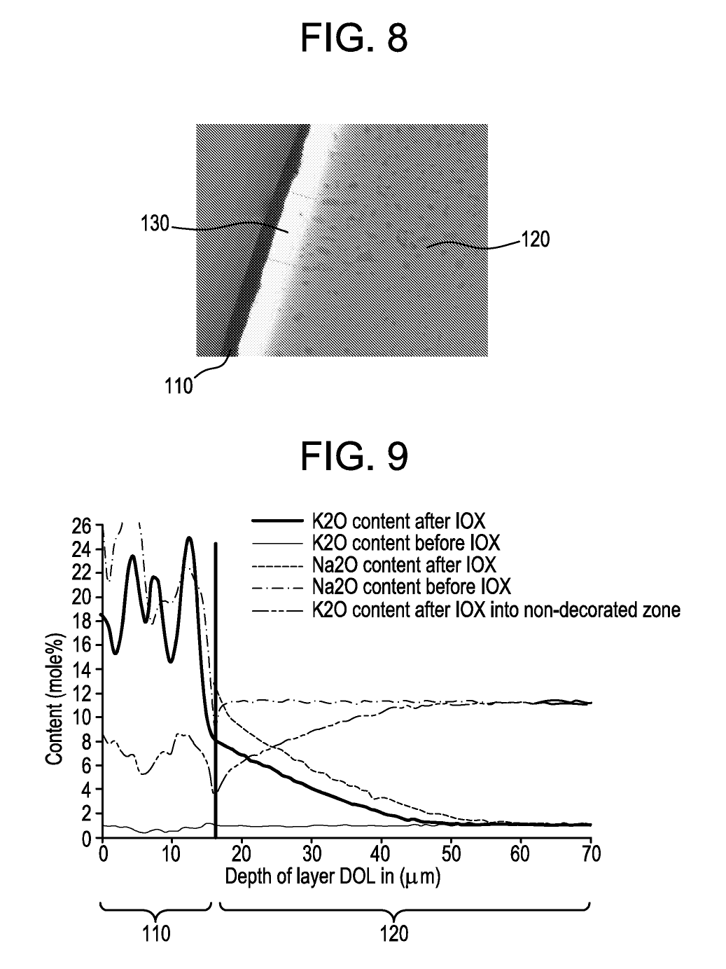

FIGS. 7-8 show images taken with a polarizing microscope of two decorative layers of non-porous, inorganic frit compositions 110 of approximately 15 μm on the chemically strengthened aluminosilicate glass substrates 120, wherein the compressive stress 130 for each can be visibly detected. The DOC for each is measured as 24 μm (FIG. 7) and 28 μm (FIG. 8) by microscope, compared to approximately 35-40 μm for the opposite (not decorated) side.

FIG. 9 is a graph showing the concentration of both Na+ and K+ ions in a decorative layer of the non-porous inorganic frit composition 110 of Example 3 (fired at 650° C. for 15 minutes) and chemically strengthened aluminosilicate glass substrate 120, both before and after ion exchange in a KNO₃ bath at 410° C. for 8 hours. This graph shows that the chemically strengthened aluminosilicate glass substrate was adequately strengthened by ion exchange under the decorative layer, as demonstrated by the presence of potassium in both the decorative layer and glass-based substrate.

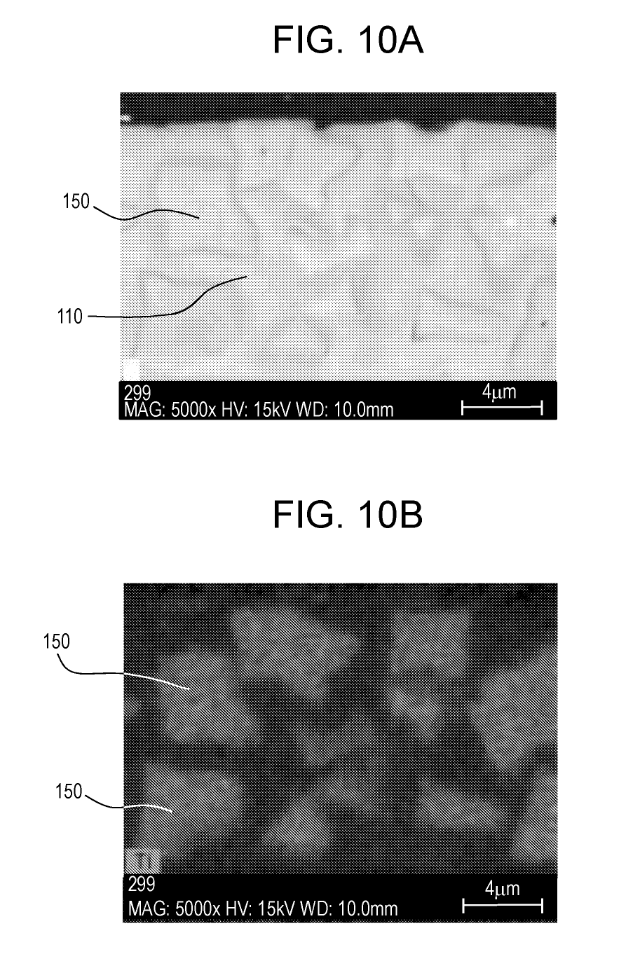

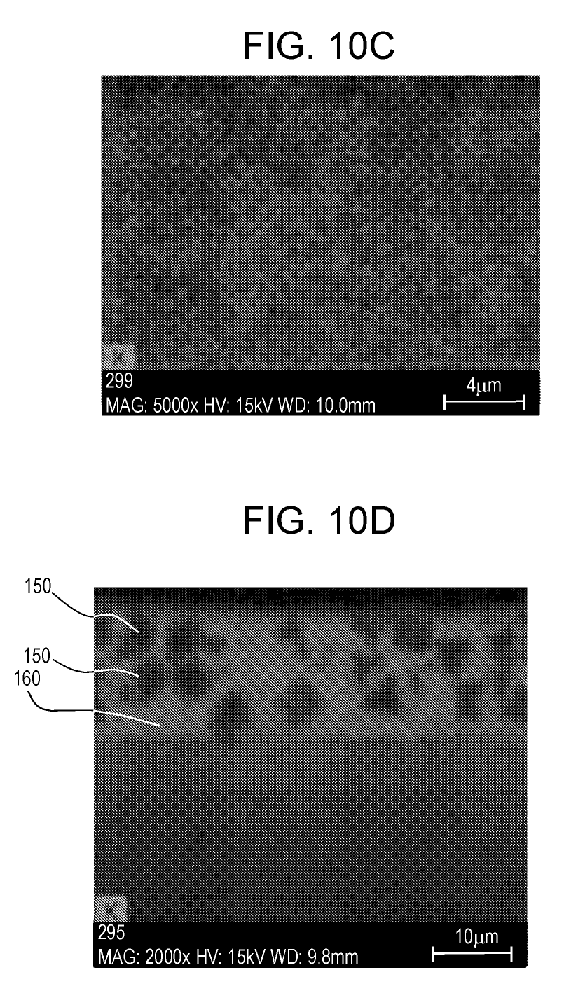

FIGS. 10A-10D show SEM/EDX images of a non-porous decorative layer made with of a frit with the composition of Example 3 (fired at 650° C. for 15 minutes) and chemically strengthened aluminosilicate glass substrate both before and after ion exchange in a KNO₃ bath at 410° C. for 8 hours. FIG. 10A is an image of the decorative layer 110. FIG. 10B shows the crystals 150 in the layer by titanium analysis.

1. An inorganic frit composition comprising:
P₂O₅ in an amount ranging from 30 mol % to about 40 mol %,
Nb₂O₅ in an amount ranging from about 5 mol % to about 15 mol %,
ZnO in an amount ranging from about 15 mol % to about 30 mol %, and
Na₂O in an amount ranging from about 15 mol % to about 30 mol %.

2. The inorganic frit composition of claim 1, comprising:
P₂O₅ in an amount ranging from about 35 mol % to about 38 mol %,
Nb₂O₅ in an amount ranging from about 7 mol % to about 13 mol %,
ZnO in an amount ranging from about 19 mol % to about 25 mol %, and
Na₂O in an amount ranging from about 19 mol % to about 25 mol %.

3. The inorganic frit composition of claim 1, wherein the composition comprises a crystallization onset temperature when measured at a heating rate of 10° C./minute (Tx), a glass transition temperature, and a ΔT greater than about 80° C., wherein ΔT is the difference between Tx and Tg.

4. The inorganic frit composition of claim 1, further comprising at least one of TiO₂, K₂O, Li₂O, SiO₂, and Al₂O₃.

5. The inorganic frit composition of claim 1, further comprising at least one pigment.

6. The inorganic frit composition of claim 1, which is fired.

7. The inorganic fit composition of claim 4, comprising an NZP-type crystalline phase.

8. An article comprising:
a strengthened glass-based substrate; and
a non-porous inorganic frit composition layer comprising P₂O₅, Nb₂O₅, ZnO, and Na₂O,
wherein the non-porous inorganic frit composition layer comprises an NZP-type crystalline phase.

9. The article of claim 8, wherein the non-porous inorganic frit composition layer further comprises at least one of TiO₂, K₂O, Li₂O, SiO₂, and Al₂O₃.

10. The article of claim 8, wherein the non-porous inorganic frit composition layer further comprises at least one pigment.

11. The article of claim 8, wherein the glass-based substrate comprises aluminosilicate glass or aluminoborosilicate glass.

12. The article of claim 8, wherein the CTE of the inorganic frit composition layer is compatible with the CTE of the glass-based substrate.

13. A method of forming a strengthened glass-based substrate, said method comprising:
providing an ion-exchangeable glass-based substrate;
depositing a layer of a frit composition onto the glass-based substrate, wherein the frit composition comprises P₂O₅, Nb₂O₅, ZnO, and Na₂O, a crystallization onset temperature when measured at a heating rate of 10° C./minute (Tx), a glass transition temperature, and a ΔT greater than about 80° C., wherein ΔT is the difference between Tx and Tg;
firing the glass-based substrate and deposited frit composition layer at a temperature and for a time sufficient to form a decorated glass-based substrate comprising a non-porous inorganic frit composition layer having an NZP-type crystalline phase; and
strengthening the decorated glass-based substrate by subjecting the decorated glass-based substrate to an ion-exchange process.

14. The method of claim 13, wherein the frit composition comprises P₂O₅ in an amount ranging from about 35 mol % to about 38 mol %, Nb₂O₅ in an amount ranging from about 7 mol % to about 13 mol %, ZnO in an amount ranging from about 19 mol % to about 25 mol %, and Na₂O in an amount ranging from about 19 mol % to about 25 mol %.

15. The method of claim 13, wherein firing the glass-based substrate and deposited frit composition layer comprises firing at a temperature ranging from about 500° C. to about 750° C., during 5 minute intervals with heating and cooling ramps ranging from about 20° C./min to about 50° C./min.

16. The method of claim 13, wherein strengthening the decorated glass-based substrate by subjecting the decorated glass-based substrate to an ion-exchange process comprising immersing the decorated glass-based substrate in a KNO₃ bath at a temperature ranging from about 400° C. to about 480° C. for a period in a range from 1 hour to about 24 hours.

17. The method of claim 13, wherein the CTE of the non-porous inorganic frit composition layer is compatible with the CTE of the glass-based substrate.

18. A laminate comprising:
an external glass substrate comprising an unstrengthened glass substrate;
an interlayer disposed on the external glass substrate;
an internal glass substrate disposed on the interlayer, the internal glass substrate comprising a chemically strengthened glass substrate; and
the inorganic frit of claim 13 disposed on at least one or both the external glass substrate and the internal glass substrate.

19. A vehicle comprising: a body defining an interior; an opening in the body in communication with the interior; and the laminate of claim 18 disposed in the opening.

20. The vehicle of claim 19, wherein the body comprises an automobile body, a railcar body, or an airplane body, wherein the internal glass substrate faces the interior.
